(19) United States
(12) Patent Application Publication
(10) Pub. No.: US 2024/0220599 A1
(43) Pub. Date: Jul. 4, 2024

(54) Multi-Level Virtual Resource Authentication

(71) Applicant: Micro Focus LLC, Santa Clara, CA (US)

(72) Inventors: Douglas Max Grover, Rigby, ID (US); Michael F. Angelo, Houston, TX (US)

(73) Assignee: Micro Focus LLC, Santa Clara, CA (US)

(21) Appl. No.: 18/149,623

(22) Filed: Jan. 3, 2023

(51) Int. Cl. G06F 21/45

(52) U.S. Cl. CPC G06F 21/45

(57) ABSTRACT

A request to grant control of a virtual resource is received. For example, a user may provide a set of authentication credentials that allow the user to execute a virtual machine. The request to grant control of the virtual resource uses an authentication level of a plurality of authentication levels associated with the virtual resource. The request to grant control of the virtual resource is validated. In response to validating the request to grant control of the virtual resource, control of the virtual resource is granted according to the authentication level of the plurality of authentication levels associated with the virtual resource. The user can then control/access the virtual resource based on privileges associated with the authentication level.

### FIELD

The disclosure relates generally to virtual resources and particularly to providing authentication/access services to virtual resources.

### BACKGROUND

Currently, authentication in a virtualized environment is static and inflexible. Because of this inflexibility, management of virtualized resources can be difficult.

### SUMMARY

These and other needs are addressed by the various embodiments and

configurations of the present disclosure. The present disclosure can provide a number of advantages depending on the particular configuration. These and other advantages will be apparent from the disclosure contained herein.

A request to grant control of a virtual resource is received. For example, a user may provide a set of authentication credentials that allow the user to execute a virtual machine. The request to grant control of the virtual resource uses an authentication level of a plurality of authentication levels associated with the virtual resource. The request to grant control of the virtual resource is validated. In response to validating the request to grant control of the virtual resource, control of the virtual resource is granted according to the authentication level of the plurality of authentication levels associated with the virtual resource. The user can then control/access the virtual resource based on privileges associated with the authentication level.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112. Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for providing multi-level virtual resource authentication.

FIG. 2 is a flow diagram of a process for providing multi-level virtual resource authentication.

FIG. 3 is a flow diagram of a process for providing additional multi-level virtual resource authentication.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

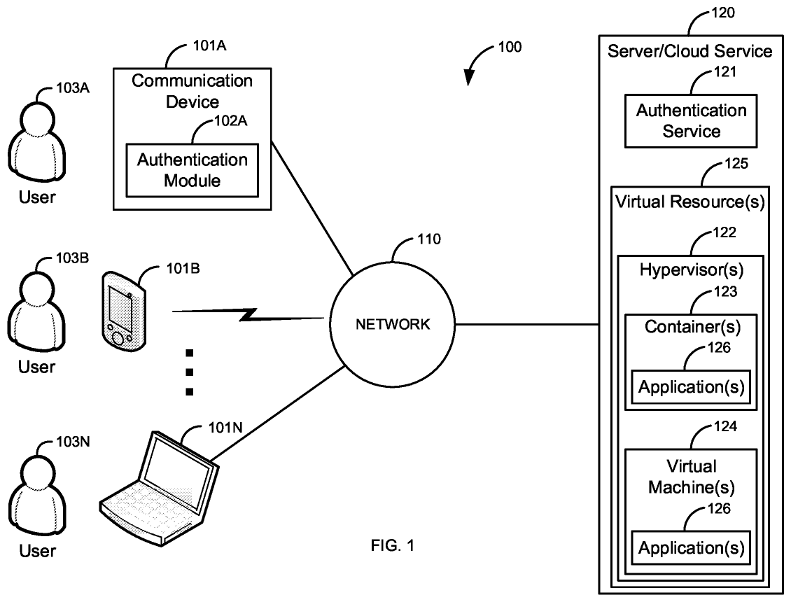

FIG. 1 is a block diagram of a first illustrative system 100 for providing multi-level virtual resource authentication. The first illustrative system 100 comprises communication devices 101A-101N, a network 110, and a server/cloud service 120. In addition, users 103A-103N are shown for convenience.

The communication devices 101A-101N can be or may include any user device that can communicate on the network 110, such as a Personal Computer (PC), a cellular telephone, a Personal Digital Assistant (PDA), a tablet device, a notebook device, a smartphone, a laptop computer, and/or the like. As shown in FIG. 1, any number of communication devices 101A-101N may be connected to the network 110, including only a single communication device 101.

The communication devices 101A further comprises an authentication module 102A. The authentication module 102A can be any software/process that allows the user 103A to authenticate to the server/cloud service 120. For example, the authentication module 102A may be a software application that resides on the communication device 101A. Alternatively, the authentication module 102A may be a web application running in a browser that is downloaded via the server/cloud service 120. Although not shown in FIG. 1, the communication devices 101B-101N may also comprise an authentication module 102 (e.g., authentication modules 102B-102N).

The users 103A-103N can be any human user 103 that accesses the communication devices 101A-101N. The users 103A-103N may have various roles/privileges on the server/cloud service 120.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network 110 configured to carry messages via packets and/or circuit switched communications.

The server/cloud service 120 can be or may include any server or collection of servers that provides virtualized services on the network 110. The virtualized services may be provided by the hypervisor(s) 122, the container(s) 123, the virtual machine(s) 124, micro service(s), and/or the like.

The server/cloud service 120 further comprises an authentication service 121. The authentication service 121 allows a user 103, via a communication device 101, to authenticate to the virtualized services provided by the server/cloud service 120. The authentication service 121 uses authentication levels to control various aspects of the virtualized services, such as, granting access, granting access to one or more applications 126 in a virtual resource 125, an ability to execute a virtual resource 125, an ability to spawn a virtual resource 125 (e.g., to spawn a first container 123 from a second container 123), an ability to construct (create) a virtual resource 125 (e.g., an ability to create a virtual machine 124 or container 123), an ability to construct a specific type of virtual resource 125 (e.g., the ability construct a type one bare metal hypervisor 122 versus a type two hosted hypervisor 122), and/or the like.

The hypervisor 122 may be any type of hypervisor 122 that can run the containers 123 and/or virtual machines 124. The hypervisor 122 may be a bare metal hypervisor 122, a hosted hypervisor 122, and/or the like.

The container(s) 123 may be any type of container 123, such as, a Docker container, a Kubernetes container, and/or the like. The container(s) 123 may be micro service(s). The container(s) 123 may have an image. For example, the container(s) 122 may comprise a Docker image, a container image, and/or the like. The image is a stored image of the application(s) 126 that run in the container 123. The container image may also contain configuration information associated with authentication/control of the container 123.

The container(s) 123 further comprise one or more applications 126. An application 126 may be any type of application 126 that can run in the container 123, such as a security application, a database application, a web application, a word processing application, a spreadsheet, a graphics program, an email application, a video program, and/or the like.

The virtual machine(s) 124 may be any type of virtual machine 124, such as, a process virtual machine 124, a system virtual machine 124, and/or the like. The virtual machine(s) 124 may also comprise an image. The virtual machine image contains the operating system/applications 126 that run in the virtual machine 124. The virtual machine image may also contain configuration information associated with authentication/control of the virtual machine 124. The virtual machines 124 also comprise one or more applications 126.

The virtual resource(s) 125 may be any type of virtual resource 125. For example, a virtual resource 125 may be the hypervisor(s) 122, the container(s) 123, the virtual machine(s) 124, a micro service, and/or the like.

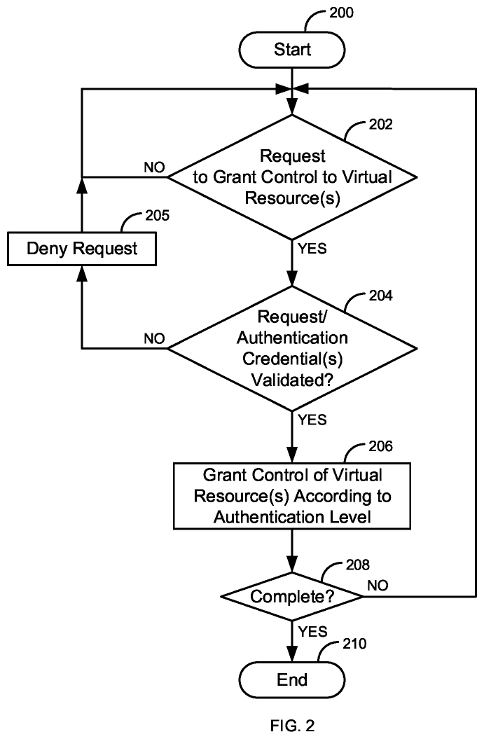

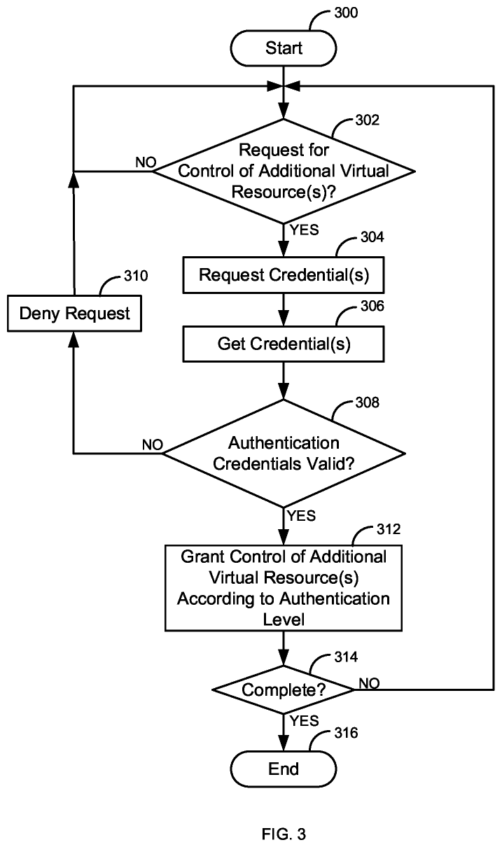

FIG. 2 is a flow diagram of a process for providing multi-level virtual resource authentication. Illustratively, the communication devices 101A-101N, the authentication module 102A, the server/cloud service 120, the authentication service 121, the hypervisor(s) 122, the container(s) 123, the virtual machine(s) 124, the virtual resource(s) 125, and the application(s) 126 are stored-program-controlled entities, such as a computer or microprocessor, which performs the method of FIGS. 2-3 and the processes described herein by executing program instructions stored in a computer readable storage medium, such as a memory (i.e., a computer memory, a hard disk, and/or the like). Although the methods described in FIGS. 2-3 are shown in a specific order, one of skill in the art would recognize that the steps in FIGS. 2-3 may be implemented in different orders and/or be implemented in a multi-threaded environment. Moreover, various steps may be omitted or added based on implementation.

The process starts in step 200. The authentication service 121 waits, in step 202, for a request to grant control to one or more virtual resource(s) 125. If a request is not received in step 202, the process of step 202 repeats.

Otherwise, if a request to grant control to a virtual resource(s) 125 has been received in step 202, the authentication service 121 validates the authentication credential(s) provided by the user 103 in step 204. For example, the authentication service may validate a username/password provided by the user 103. If the authentication credential(s) are invalid in step 204, the request is denied, in step 205, and the process goes back to step 200.

Otherwise, if the authentication credentials are valid in step 204, the authentication service 121 grants control of the virtual resource(s) 125 according to the authentication level in step 206. The authentication credential(s) are used for different authentication levels (i.e., multi-factor authentication). When discussing an authentication level, there are one or more corresponding authentication credentials. For example, level one authentication may require a username/password, level two authentication, a username/password and a Short Message Service (SMS) code, level three authentication, a username/password, SMS code, and a fingerprint scan, and level four authentication, a username/password, a SMS code, and an iris scan. In one embodiment, each authentication level may require one or more additional authentication credentials. The combination of authentication credentials for an authentication level may vary in number based on a variety of factors, such as, the user 103, a type of user (e.g., a super user 103 versus a regular user 103), a type of container 123/virtual machine 124, a type of application 126 in a container 123/virtual machine 124, a type of hypervisor 122 (e.g., type one or type two), a security level, a network topology, a location of the user 103, a type of micro service, and/or the like.

The request to grant control may use multi-factor authentication to get access to different hypervisor(s) 122, container(s) 123/virtual machine(s) 124 and/or configurations of virtual resource(s) 125. For example, as shown below in Table 1, by providing the proper authentication credentials for the authentication level one, the user 103A is granted access to the container 123A (a loaded/running container 123). Providing the proper authentication credentials for level two authentication, the user 103A is granted access to the loaded/running container 123B. By providing the proper authentication credentials for level three authentication, the user 103A is granted access to both the loaded/running containers 123A/123B.

For the user 103B, the authentication level one does not grant access to any running/loaded containers 123. However, the user 103B can get access to the loaded/running container 123A by providing the proper authentication credentials for level two authentication. The user 103B has no access to container 123B.

TABLE 1

| User | Authentication Level | Access |
|---|---|---|
| User 103A | Level 1 | Container 123A |
| User 103A | Level 2 | Container 123B |
| User 103A | Level 3 | Containers 123A/123B |
| User 103B | Level 1 | None |
| User 103B | Level 2 | Container 123A |

The process can be extended to include authorization to execute/spawn for a virtual resource 125 as shown in Table 2. If the user 103A authenticates at level one, the user 103A has the ability to access the container 123A. For authentication level two, the user 103A can access and execute (load) the container 123A. For example, the user can load the container 123A from a stored Docker image of the container 123A. For authentication level three, the user 103A can access both containers 123A/123B, execute container 123A, and spawn the container 123C from the container 123A. For authentication level four, the user 103A can access the containers 123A/123B, execute the containers 123A/123B, and spawn any containers 123 from the containers 123A/123B. The access, execute, spawn attributes (control types) may be different for different users 103.

TABLE 2

| | Authentication | | | |
|---|---|---|---|---|
| User | Level | Access | Execute | Spawn |
| User 103A | Level 1 | Container | No | No |
| | | 123A | | |
| User 103A | Level 2 | Container | Container | No |
| | | 123A | 123A | |
| User 103A | Level 3 | Containers | Container | Yes |
| | | 123A/123B | 123A | (Container |
| | | | | 123C from |
| | | | | Container |
| | | | | 123A) |
| User 103A | Level 4 | Containers | Containers | All from |
| | | 123A/123B | 123A/123B | Containers |
| | | | | 123A/123B |

If the user 103A is authenticated at level one, and the container 123A tries to spawn the container 123C, the user 103A may be asked to provide the remaining authentication credentials for level three authentication. For example, if the level three authentication credentials are username/password, SMS code, and fingerprint scan and the user 103A has already provided the username/password (level one), the user 103A will be asked to provide a SMS code/fingerprint scan in order to spawn the container 123C from the container 123A.

Although Tables 1 and 2 are described using containers 123, each of the attributes may apply any virtual resource 125/combination of virtual resources 125 and/or users 103. For example, execute privileges may apply to a virtual machine 124 and/or a hypervisor 122. In addition, the attributes may apply to different types of hypervisors 122, containers 123 and/or virtual machines 124. For example, the containers 123/virtual machines 124 may have group attributes (e.g., type one/type two containers 123/virtual machines 124).

The execute, access, and spawn attributes may be stored as part of a container and/or virtual machine image. For example, the attributes may be stored in a Docker container image. Thus, when the user 103 does not have the necessary credentials for each attribute, the user 103 will be denied the particular ability when the image is loaded. For example, the authentication service 121 may read the attributes from the image to see if the user 103 has permissions to execute the container 123A based on providing the proper level two authentication credentials.

In addition, the execute, access, and spawn attributes may be defined/stored as part of a hypervisor 122. In this embodiment, the hypervisor 122 itself will control access to each of the containers 123/virtual machines 124 and their attributes (execute, access, and spawn). In one embodiment, access/execute attributes for a hypervisor 122 may apply to the authentication levels. For example, the authentication levels may apply to the user's ability to access/execute a type one versus a type two hypervisor 122.

Another attribute/control type that can be controlled by the multi-factor authentication/authentication level is the ability to construct/create a container 123/virtual machine 124 and what specific applications 126 can be added to and/or executed in the container 123/virtual machine 124. In order to construct a container 123 (or specific type of container 123), the user 103A authenticates at a specific authentication level. For example, as shown in Table 3, the user 103A must authenticate at level two to construct the container type 1 where the container type one does not have specific security application(s) 126. In other words, the user 103 may construct the container type one with any applications 126 with the exception of specific defined security application(s) 126. The user 103A must authenticate at authentication level three to construct container types one and two (but could be only container type two) without the specific security applications(s) 126. The user 103A must authenticate at authentication level four to construct the container types 1 and 2 with any kind of application 126.

TABLE 3

| User | Authentication Level | Construct |
|---|---|---|
| User 103A | Level 1 | None |
| User 103A | Level 2 | Container Type 1 - No |
| | | Security Apps |
| User 103A | Level 3 | Container Types 1 and 2 - |
| | | No Security Apps |
| User 103A | Level 4 | Container Types 1 and 2 |
| | | and All Apps |

Although Table 3 only discusses containers 123, it can also apply to any virtual resource, such as, hypervisors 122, virtual machines 124, a combination of containers 123/virtual machines 124/hypervisors 122 and/or different combinations of users 103. In addition, additional attributes/control types associated with construction of a hypervisor 122/container 123/virtual machine 124 may apply, such as, specific application functionality, administrative attributes of the container 123/virtual machine 124, and/or the like.

The multi-factor authentication levels can be used to construct a virtual resource 125 based on resources used by the virtual resource 125. For example, as shown in Table 4, the user 103A authenticates at level one and can construct the container 123A with specific resources (32 Gig Memory, 1 TB Disk Space, and 4 Cores). At level two authentication, the user 103A can construct a container 123B with 64 Gig Memory, 10 TB Disk Space, and 16 Cores. Level two may also include the ability to construct the container 123A. At level three authentication, the user 103A can create a container 123C with 128 Gig Memory, 100 TB Disk Space, and 64 Cores. At level three, the user 103A may also be able to create the containers 123A and/or 123B.

TABLE 4

| User | Authentication Level | Construct |
|---|---|---|
| User 103A | Level 1 | 32 Gig Memory, 1 TB Disk |
| | | Space, 4 Cores (123A) |
| User 103A | Level 2 | 64 Gig Memory, 10 TB Disk |
| | | Space, 16 Cores (123B) |
| User 103A | Level 3 | 128 Gig Memory, 100 TB Disk |
| | | Space, 64 Cores (123C) |

After granting control of the virtual resource(s) 125 according to the authentication level in step 206, the authentication service 121 determines, in step 208, if the process is complete. If the process is not complete in step 208, the process goes back to step 202. Otherwise, the process ends in step 210.

FIG. 3 is a flow diagram of a process for providing additional multi-level virtual resource authentication. The process starts in step 300. The authentication service 121 determines, in step 302, if a request for control of additional virtual resources 125 is received. For example, if the user 103 has authenticated at level one and currently has container access privileges, but not execute privileges, if the user 103 is trying to execute the container 123, the user 103 is making a request for control of additional virtual resource(s) 125 (execute privileges) in step 302. If a request is not received in step 302, the process of step 302 repeats.

Otherwise, if a request for control of additional virtual resources 125 is received in step 802, the authentication service 121 requests the authentication credential(s) (assuming that the user 103 is allowed) in step 304. The authentication service 121 gets the credential(s) in step 306. The authentication service 121 determines, in step 308, if the authentication credentials are valid and match the necessary authentication level. If the credentials are not valid and/or do not match the necessary authentication level in step 308, the request is denied in step 310 and the process goes to step 302.

Otherwise, if the authentication credentials are valid in step 308, the authentication service 121 grants control of the additional virtual resources 125 according to the authentication level in step 312. The authentication service 121 determines, in step 314, if the process is complete. If the process is not complete in step 314, the process goes back to step 302. Otherwise, if the process is complete in step 314, the process ends in step 316.

Examples of the processors as described herein may include, but are not limited to, at least one of Qualcomm® Snapdragon® 800 and 801, Qualcomm® Snapdragon® 610 and 615 with 4G LTE Integration and 64-bit computing. Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving case and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
receive a request to grant control of a first virtual resource, wherein the request to grant control of the first virtual resource uses a first authentication level of a plurality of authentication levels associated with the first virtual resource;
validate the request to grant control of the first virtual resource; and
in response to validating the request to grant control of the first virtual resource, grant control of the first virtual resource according to the first authentication level of the plurality of authentication levels associated with the first virtual resource.

2. The system of claim 1, wherein granting control of the first virtual resource comprises granting access to the first to the first virtual resource.

3. The system of claim 1, wherein granting control of the first virtual resource comprises granting access to one of a plurality of applications in the first virtual resource.

4. The system of claim 1, wherein granting control of the first virtual resource comprises an ability to execute the first virtual resource.

5. The system of claim 1, wherein granting control of the first virtual resource comprises an ability to spawn a second virtual resource from the first virtual resource.

6. The system of claim 1, wherein granting control of the first virtual resource comprises an ability to construct the first virtual resource.

7. The system of claim 1, wherein granting control of the first virtual resource comprises an ability to construct a type of the first virtual resource.

8. The system of claim 7, wherein the ability to construct the type of the first virtual resource comprises at least one of: an amount of memory, an amount of disk space, a number of processor cores, a type of application in the virtual resource, specific application functionality, and administrative attributes of the virtual resource.

9. The system of claim 1, wherein the first virtual resource comprises a plurality of virtual resources and wherein granting control of the first virtual resource comprises granting control of the plurality of virtual resources.

10. The system of claim 1, wherein the plurality of authentication levels associated with the first virtual resource are associated with a plurality of virtual resources and wherein a second authentication level of the plurality of authentication levels provides control of a second virtual resource.

11. The system of claim 1, wherein the plurality of authentication levels comprises a second authentication level, wherein the first authentication level provides a first control type for the first virtual resource and wherein the second authentication level provides a second control type for the first virtual resource.

12. The system of claim 1, wherein control of the first virtual resource is based on attributes stored within an image of the first virtual resource.

13. A method comprising:
receiving, by a microprocessor, a request to grant control of a first virtual resource, wherein the request to grant control of the first virtual resource uses a first authentication level of a plurality of authentication levels associated with the first virtual resource;
validating, by the microprocessor, the request to grant control of the first virtual resource; and
in response to validating the request to grant control of the first virtual resource, granting, by the microprocessor, control of the first virtual resource according to the first authentication level of the plurality of authentication levels associated with the first virtual resource.

14. The method of claim 13, wherein granting control of the first virtual resource comprises granting access to one of a plurality of applications in the first virtual resource.

15. The method of claim 13, wherein granting control of the first virtual resource comprises an ability to execute the first virtual resource.

16. The method of claim 13, wherein granting control of the first virtual resource comprises an ability to spawn a second virtual resource from the first virtual resource.

17. The method of claim 13, wherein the first virtual resource comprises a plurality of virtual resources and wherein granting control of the first virtual resource comprises granting control of the plurality of virtual resources.

18. The method of claim 13, wherein the plurality of authentication levels comprises a second authentication level, wherein the first authentication level provides a first control type for the first virtual resource and wherein the second authentication level provides a second control type for the first virtual resource.

19. The method of claim 13, wherein control of the first virtual resource is based on attributes stored within an image of the first virtual resource.

20. A non-transient computer readable medium having stored thereon instructions that cause a processor to execute a method, the method comprising instructions to:
receive a request to grant control of a first virtual resource, wherein the request to grant control of the first virtual resource uses a first authentication level of a plurality of authentication levels associated with the first virtual resource;
validate the request to grant control of the first virtual resource; and
in response to validating the request to grant control of the first virtual resource, grant control of the first virtual resource according to the first authentication level of the plurality of authentication levels associated with the first virtual resource.
